(19) United States
(12) Patent Application Publication
(10) Pub. No.: US 2018/0039969 A1
(43) Pub. Date: Feb. 8, 2018

(54) REUSABLE PAYMENT DEVICES FOR PAY-AS-YOU-GO PRODUCTS

(71) Applicant: KONINKLIJKE PHILIPS N.V., EINDHOVEN (NL)

(72) Inventors: Albert GARCIA TORMO, Eindhoven (NL); Doortje VAN DE WOUW, Eindhoven (NL); Mark Richard BENNETT, Woodhouse Eaves (GB); Venkata Sriram PULLELA, Bangalore (IN); Bahaa Eddine SARROUKH, Helmond (NL); Vasu POOJARY, Bangalore (IN); Anil Shivram RAIKER, Goa (IN)

(21) Appl. No.: 15/549,314

(22) PCT Filed: Feb. 8, 2016
(86) PCT No.: PCT/IB2016/050640

§ 371 Date: Aug. 7, 2017

(30) Foreign Application Priority Data
Feb. 9, 2015 (IN) 625/CHE/2015

(51) Int. Cl. G06Q 20/26; G06Q 20/32; G06Q 20/40

(52) U.S. Cl. CPC G06Q 20/26; G06Q 20/405; G06Q 20/3226

(57) ABSTRACT

Methods and devices are disclosed for a reusable PaYG dongle (10) including a data connection (11) arranged to connect to one or more PaYG products (20) and transfer data (17) to the one or more PaYG product (20) and an input unit arranged to receive an external signal (18). A controller (12) is arranged to process the external signal (18) and transfer the enable signal (17) using the data connection (11) to the one or more PaYG products (20) based upon the external signal (18). The methods are for enabling the one or more PaYG products (20) using the reusable PaYG dongle (10).

The present invention relates to a methods, systems and devices which perform small payments to temporarily or permanently enable Pay-as-You-Go (PaYG) devices and which may be reused between different PaYG devices.

The price of some products is too high for some consumers to be paid all at once. For example, in many markets, consumer cannot afford to pay for the total cost of an automobile or washing machine all at once and need to make installment payments. This situation is not limited to higher cost items like automobiles. Base-of-the-Pyramid (BoP) consumers have this problem for many products and/or services.

In this regard, BoP consumers have very limited resources and generally irregular incomes. They also do not have bank or savings accounts. As a result, BoP consumers have only have cash for daily or, at most, weekly purchasing. There is no chance for them to save money, so they have to organize their life day by day, purchasing almost every day small amounts of food and goods to ‘survive’. This situation forces them to think, only, in short term. In rural areas, energy is also purchased on a weekly basis, for instance kerosene for lighting (BoP consumers purchase kerosene on a weekly basis, with payments in the range of 0.50 US$˜1.00 US$) or recharging mobile phones (about 0.20 US$ per recharge).

BoP consumers can only afford reduced-amount payments for daily needs, which hinders the possibility of introducing products based on new technologies to BoP markets, such as low-power lighting or solar panels for in-house electric energy sources. Although energy efficient solar lamps are paid off within 3-6 months based on current kerosene costs, BoP consumers simply do not have the cash available to pay them at once.

In order to sell energy-efficient devices in BoP markets, new business models have been developed so that both companies and BoP consumers can benefit from them. For example, Pay as You Go (PaYG) models are systems of payment in which bills are paid when they are due or goods and services are paid for when they are bought.

For example, a type of mobile phone service subscription which allows cell phone users to pay in advance for talk time, and add more airtime as needed, by day, week or month. Such pay-as-you-go telecommunication services require no contract, and often no sign-up fees other than mobile phone service hook-up. Usually airtime is purchased in the form of a scratch card where the user inputs a code from the card to use the purchased airtime minutes.

PaYG business models also include various models where consumers purchase a device or obtain a service for a reduced amount and, whenever the device or service is to be used, a small payment is required to enable it. In general, the small payments are only required until a certain amount has been paid (pay off). Then the product, for example, is released and can be used without any further payment. There are also implementations wherein the product is never released (pure leasing).

Either if products are released after a certain amount of time/payments or not, they need to accept this kind of small payments. Companies therefore need to adapt their products to make them compatible with the PaYG model. This requires enabling/disabling the device and handling the payments, which can be accepting electronic money from an external device, communicating with a payment company or other means.

There are several manners for implementing these functionalities, for example, embedding a SIM card in the device, providing it with a keypad, using a speaker of a mobile phone to play a coded audio clip. There are a number of conventional devices arranged for use with PaYG technologies to adapt existing products to PaYG.

However, the cost of such PaYG enabling technologies (the additional hardware required to implement PaYG in products) is also reflected in the total amount that consumers need to pay. The cost of the PaYG enabling technologies is a significant obstacle in the implementation of PaYG for low- to mid-end products (e.g., whose price is below 100$ (typically around 30$)). For such low- to mid-end products, this may result in a significant price increase. There exist also cheaper solutions, like direct connection via USB cable, but they also require some additional hardware from the consumer/users (such as a smartphone).

None of the conventional PaYG enabling technologies discussed above are designed to address the low- to mid-end products. The conventional PaYG enabling technologies are standalone (i.e., the hardware/technology necessary is embedded in each PaYG product). Also in such conventional PaYG enabling technologies, once the payment of the PaYG product has finished all hardware/technology built-in the PaYG product remains there but no longer provides any use, so its value is lost.

Accordingly, a need exists in the art for systems, methods and devices to address the shortcomings of the conventional systems described above.

One embodiment of the present invention is directed to an external dongle that can be connected to any PaYG-capable device. In this regard, such dongles are no longer PaYG product specific. In addition, the cost for the overhead PaYG enabling technologies is not significant compared to the price of the PaYG product itself and the consumer is not required to obtain advanced hardware or devices (e.g., a smartphone) to use them.

Such external dongles of the present invention overcome the various issues described above. For example, most of the hardware required to implement a PaYG product is external. This allows for the reuse of the external dongle with different PaYG products and possible even different consumers.

Also the cost of the external dongle may be shared as part of the overall cost of numerous PaYG products so that the effective cost per PaYG is lower. The external dongle can be rented, sold back or even sold to other consumers later. Furthermore, the hardware overhead in the PaYG product is also reduced.

For example, in one embodiment of the present invention only an interface connector (e.g., USB, which may already be present depending on the product) in the PAYG product plus some logic to enable/disable the device (unavoidable in all PaYG implementations, otherwise the PaYG product could be used without carrying out the payments) is needed. This allows using PaYG models in mid- and even low-end products.

One aspect of the present invention is that PaYG products need to communicate with the external dongle, so there must be a compatible connector in both the dongle and the PaYG device. The PaYG product also needs some intelligence (e.g. some logic), so that the PaYG product itself can be enabled/disabled and to guarantee that the PaYG device can only be enabled by the external dongle.

One embodiment of the present invention is directed to a reusable PaYG dongle including a data connection arranged to connect to one or more PaYG products and transfer data to the one or more PaYG product and an input unit arranged to receive an external signal. A controller is arranged to process the external signal and transfer an enable signal using the data connection to the one or more PaYG products based upon the signal.

In another embodiment of the present invention the controller is further arranged to communicate with a control center to facilitate a payment that triggers reception of the signal by the PaYG dongle.

Another embodiment of the present invention is directed to a method for enabling one or more PaYG products using a reusable PaYG dongle. The method includes the steps of providing an external signal to the PaYG dongle and based upon the signal providing an enable signal to the one or more PaYG products. The method may also include the steps of selling or leasing the PaYG dongle to a user and making, by the user, a payment to obtain the external signal.

It is also noted that while various embodiments of the present invention may be used in the BoP market, the various embodiments may also have applications in other more developed world markets.

In general, the various aspects and embodiments of the present invention may be combined and coupled in any way possible within the scope of the invention. The subject matter that is regarded as the invention is particularly pointed out and distinctly claimed in the claims at the conclusion of the specification.

The foregoing and other features and advantages of the invention will be apparent from the following detailed description taken in conjunction with the accompanying drawings.

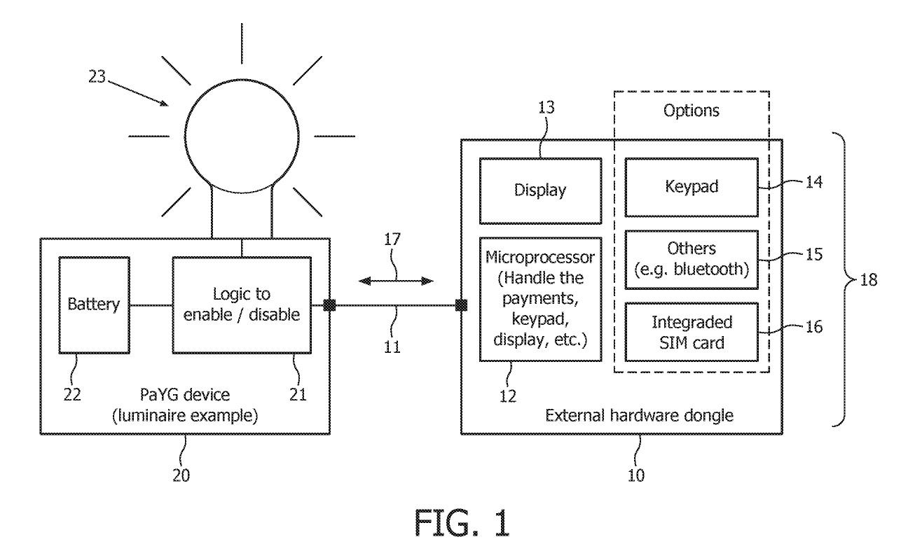

FIG. 1 shows an example of a PaYG dongle 10 and a PaYG product 20.

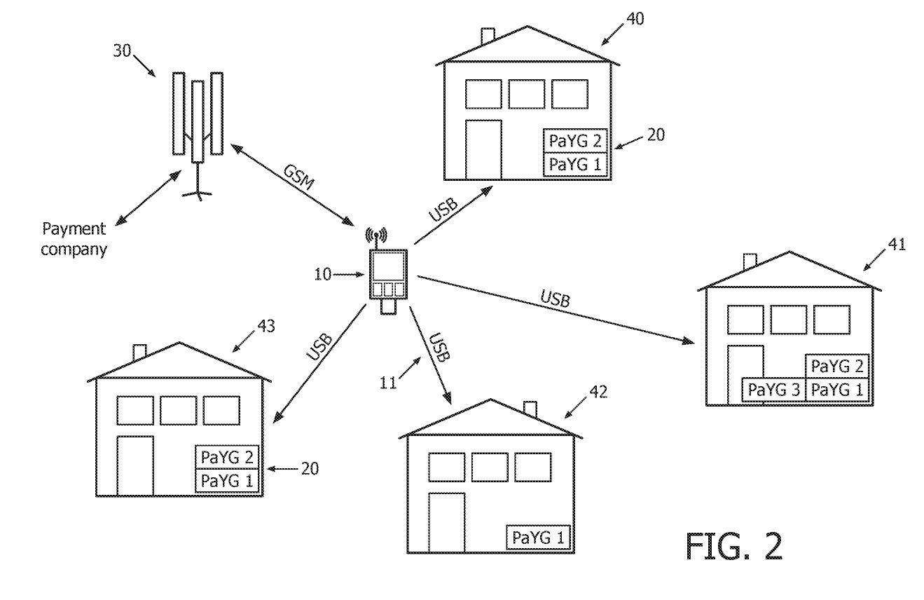

FIG. 2 shows a configuration of a PaYG system.

As noted above, there are many ways of implementing the PaYG model. Even once the PaYG model is defined, there are different possibilities for implementing a payment system. In the present invention, any type of public or private financial system supporting transfer of funds from users/customers, directly or indirectly, to providers of PaYG products can be implemented. This can be done through exchange of debits and credits among financial institutions, for example, using a paper-based mechanism for handling checks and drafts, or a paperless mechanism (such as electronic funds transfer) for handling electronic commerce transactions.

As shown in FIG. 1, the PaYG dongle 10 is connected to the PaYG product 20 via a data connection 11. In one embodiment, the data connection 11 may be a hardwire connection via a USB connector. However, the data connection 11 may be any suitable communication interface such as a hardwired link (e.g., USB or power jack) and/or a wireless interface compatible with GSM, 3G, LTE, Wi-Fi, RFID, Bluetooth, wireless mesh or another type of wireless communication system and/or a visual light communication. In this regard, the data connection 11 may be any suitable communication arrangement to transfer data 17 between the PaYG dongle 10 and one or more PaYG products 20. The transfer data 17 is used to provide an enable signal to the PaYG product 20. The enable signal indicates to the PaYG product 20 that it should activate.

The PaYG products 20 may be any type of product that can be associated with the PaYG model, e.g., energy-efficient devices, solar home systems, cellular phones, PCs, subscription services, portable lanterns, cook stoves, consumer electronics, lighting systems, heating systems, vehicles, etc. Generally any type of product that can be turned on and off may fit this model.

The PaYG dongle 10 also includes a microprocessor (or logic circuitry) 12 that controls the operation of the PaYG dongle 10. The PaYG 10 may also include a display 13, a keypad 14 and a communication interface 15 (e.g., Bluetooth as shown in the embodiment of FIG. 1). It noted that any type of input device such as touch screen, mouse, speech, etc. may be used in place of the keypad 14. When the PaYG dongle 10 receives an external signal 18 to enable the PaYG Product 20, the PaYG dongle 10 sends the enable signal 17 to the PaYG Product 20 via the data connection 11.

The PaYG dongle 10 may have a SIM card 16 so that it may directly communicate with a payment company 30 (as shown in FIG. 2). The payment company 30 is a data processing center (e.g., a service center, back office, control center, etc.) for facilitating payments and/or data transfers to and from the PaYG dongle 10. FIG. 2 shows the payment company 30 in communication (via the SIM card 16 and/or the communication interface 15 (shown as GSM in FIG. 2)) with the PaYG dongle 10. The PaYG dongle 10 is in communication (via the data connection 11 (shown as USB in FIG. 2)) with one or more PaYG products 20 located in one or more locations 40-43.

The external signal 18 to indicate that the PaYG dongle 10 should send the enable signal 17 may be received by the PaYG dongle 10 via any of the keypad 14, the communication interface 15 and/or the SIM card 16.

In other embodiments, the SIM card 16 can be eliminated and the PaYG dongle 10 may communicate with the payment company 30 via the communication interface 15 which may be for example, Wi-Fi, a dial-up phone connection, Bluetooth interface to a cellular phone, or other any other suitable communication interface capable transmitting directly or indirectly data via a public or private network. For example, the communication interface 15 may be in direct communication via a wired and/or wireless/wireless-mesh connection or an indirect communication via a network such as the Internet, Intranet, a wide area network (WAN), a metropolitan area network (MAN), a local area network (LAN), a terrestrial broadcast system, a cable network, a satellite network, a wireless network, power line or a telephone network (POTS), as well as portions or combinations of these and other types of networks.

It is noted, however, that unlike conventional credit card dongles used for sales transactions payment processes, multiple stakeholder involvement, e.g., hosting bank, telecom service provider (e.g., GSM, GPRS), payment gate as in Visa, Master etc., point of sale system service provider are not need for authenticating or completion of payment. As shown in FIG. 2, coordination for single payment with all these parties is not required.

As noted above, in some embodiments, the PaYG dongle 10 may utilize the keypad 14 and display 13 to show information to a user/consumer (not shown). The user/consumer may, for example, input account information and other relevant data to the PaYG dongle 10. The other relevant data may include identification information, time, quantity and/or usage information related to the customer and/or a particular PaYG product 20. The PaYG dongle 10 then processes the information and data via the microprocessor 12 to make a payment. Once the payment has been completed, the microprocessor 12 will enable the PaYG product 20 via data connection 11.

In one embodiment, the display 13 shows information regarding how much credit or how many hours are left before another payment is required and/or how many more payments are still to be executed before the PaYG device 20 is permanently released. In other embodiments, the display 13 shows other information such as codes and status information to be transferred to and from the PaYG product 20. In other embodiments, the PaYG dongle 10 may have include a preset number of uses for the PaYG product 20 and also a recharge (top up) feature. The PaYG dongle 10 may also track usage patterns of the PaYG product 20 for optimization of the PaYG products 20 or to recommend new products to the user that fits its behavior and need. The same PaYG may also be used or set for range of different PaYG products 20. The microprocessor 12 of the PaYG dongle 10 can also be updated via a software work with new PaYG products 20.

The PaYG product 20 includes components/logic to enable/disable itself 21, a battery or power unit 22 and functional components/units 23 (e.g., lighting unit, heating unit, pump or any other electric mechanism). The functional components/units 23 may be for any appropriate function or service the PaYG product 20 was designed to perform. The PaYG product 20 also includes a corresponding data connection to communicate with the PaYG dongle 10.

There are different scenarios and embodiments wherein the PaYG dongle 10 can be used which may require different features/components. The embodiment shown in FIG. 1 is one example of how hardware/components can be configured between the PaYG product 20 and the PaYG dongle 10.

In other embodiments, the PaYG dongle 10 can have less hardware, for instance, various components shown in FIG. 1 may not needed (e.g., the SIM card 16, the communication interface 15, keypad 14 and/or the display 13). For example, the PaYG dongle may accept codes entered via the keypad 14 or the communication interface 15 that are then sent to the PaYG product 20 to enable it. The user/consumer may purchase these codes from a brick and mortar store, via the Internet for example or entered remotely by a Bluetooth connection for example. The codes may be for specific PaYG products 20 and may specify the amount of use/time the PaYG product 20 is enabled. It should be appreciated that different codes may be used for different BoP models and different PaYG products 20.

In yet another embodiment, the PaYG dongle 10 may be configured to only accept electronic money from a trusted source via a direct connection. The PaYG dongle 10 then stores the electronic money and transfer it to the PaYG product 20 to enable it.

In other embodiments, the PaYG dongle 10 need not be provided to the user/consumer of the PaYG product 20. The PaYG dongle 10 may be in the possession of a service agent. The service agent may travel to enable the PaYG products 20 of the user/consumers who pay the required amount to the service agent.

Alternatively, the PaYG dongle 10 may be directly sold to the BoP user/consumers, so that one or more consumers own the PaYG dongle 10. The PaYG dongle 10 may also be leased or rented to users/consumers, so that no initial investment is required. For example, the user/consumer can rent the PaYG dongle 10 from the shop selling the PaYG products 20 (pay per month or deposit) and as soon as the PaYG product 20 is paid off the PaYG dongle 20 can be returned and may be used by the next user/customer.

In other embodiments, the payments made via the PaYG dongle 10 may be executed via a mobile money system. Mobile payment, also referred to as mobile money, mobile money transfer, and mobile wallet generally refer to payment services operated under financial regulation and performed from or via a mobile device. Instead of paying with cash, cheque, or credit cards, the user/consumer can use a mobile phone to pay for a wide range of services and digital or hard goods. Although the concept of using non-coin-based currency systems has a long history, it is only recently that the technology to support such systems has become widely available. In developing countries mobile payment solutions have been deployed as a means of extending financial services to the community known as the “unbanked” or “under banked,” which is estimated to be as much as 50% of the world's adult population.

In yet other embodiments, the payments made via the PaYG dongle 10 may be executed via conventional cash. In this case, an authorized agent (which could also be a physical shop) can collect the money and enable the PaYG product 20 via the PaYG dongle 10.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, and the like), the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

The principles of the present invention are implemented as any combination of hardware, firmware and software. Moreover, the software is preferably implemented as an application program tangibly embodied on a program storage unit or computer readable storage medium consisting of parts, or of certain devices and/or a combination of devices. The application program may be uploaded to, and executed by, a machine comprising any suitable architecture. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

1. A reusable PaYG dongle comprising:
a data connection arranged to connect to one or more PaYG products and transfer data to the one or more PaYG product;
an input unit arranged to receive an external signal identifying a selected one of the one or more PaYG product; and
a controller arranged to:
receive the external signal;
communicate with a payment center to receive information regarding payment;
process the received information to authorize a payment; and
transfer an enable signal using the data connection to activate the identified one of the one or more PaYG products based upon the authorization of the payment.

2. The reusable PaYG dongle according to claim 1 wherein the data connection 11 is one of: a hardwired connection and a wireless connection.

3. The reusable PaYG dongle according to claim 2 wherein the wired data connection 11 is a USB connection.

4. (canceled)

5. The reusable PaYG dongle according to claim 2 wherein the wireless data connection 11 is one of: a wireless mesh connection, a Bluetooth connection and a cellular connection.

6. The reusable PaYG dongle according to claim 1 wherein the input unit is one of: a keypad, a wireless communication unit, and a SIM card.

7. (canceled)

8. (canceled)

9. The reusable PaYG dongle according to claim 6 wherein the wireless communication unit is one of: a Bluetooth communication unit and a cellular communication unit.

10. (canceled)

11. The reusable PaYG dongle according to claim 1 further comprising a display arranged to provide information to a user.

12. A method for enabling one or more PaYG products by a reusable PaYG dongle connected to the one or more PaYG products, the method operable in the PaYG dongle comprising the steps of:
receiving an external signal identifying a selected one of the one or more PaYG products:
communicating with a payment center to receive information regarding a payment;
processing the received information to authorize a payment; and
transferring an enable signal using a data connection to activate the identified one of the one or more PaYG products based upon the authorization of the payment.

13. The method for enabling the one or more PaYG products using the reusable PaYG dongle according to claim 12 further comprising the steps of selling the PaYG dongle to a user and making, by the user, a payment to obtain the external signal.

14. The method for enabling the one or more PaYG products using the reusable PaYG dongle according to claim 12 further comprising the steps of leasing the PaYG dongle to a user and making, by the user, a payment to obtain the external signal.

15. The method for enabling the one or more PaYG products using the reusable PaYG dongle according to claim 12 wherein the external signal is an enable code provided by an input device.

16. The method for enabling the one or more PaYG products using the reusable PaYG dongle according to claim 12 wherein the authorization step is done via an electronic transaction.

17. The method for enabling the one or more PaYG products using the reusable PaYG dongle according to claim 12 wherein the authorization step is done by a paper financial transaction.

18. The method for enabling the one or more PaYG products using the reusable PaYG dongle according to claim 12 wherein the authorization is stored in a memory.
